(19) United States
(12) Patent Application Publication
(10) Pub. No.: US 2014/0320036 A1
(43) Pub. Date: Oct. 30, 2014

(54) COMPULSORY TRIGGERED SPARK GAP SYSTEM WITH DOUBLE GAPS IN SERIES

(71) Applicants: Zhifang Liu, Beijing (CN); Qinxiao Dong, Beijing (CN); Guofu Li, Beijing (CN); Keli Gao, Beijing (CN); Cuixia Zhang, Beijing (CN); Weiming Liao, Beijing (CN)

(72) Inventors: Zhifang Liu, Beijing (CN); Qinxiao Dong, Beijing (CN); Guofu Li, Beijing (CN); Keli Gao, Beijing (CN); Cuixia Zhang, Beijing (CN); Weiming Liao, Beijing (CN)

(73) Assignees: STATE GRID CORPORATION OF CHINA, Beijing (CN); CHINA ELECTRIC POWER RESEARCH INSTITUTE, Beijing (CN)

(21) Appl. No.: 14/356,153

(22) PCT Filed: Sep. 19, 2012
(86) PCT No.: PCT/CN2012/081591

§ 371 Date: May 3, 2014

(30) Foreign Application Priority Data
Nov. 3, 2011 (CN) 201120429075.3

(51) Int. Cl. H01T 15/00

(52) U.S. Cl. CPC H01T 15/00
USPC 315/238

(57) ABSTRACT

The present utility model provides a compulsory triggered spark gap system with double gaps in series, said spark gap system includes two self-discharge main gaps in series G1, G2 and a gap trigger system, the two ends of the spark gap system are respectively connected with the high voltage end and low voltage end; said gap trigger system and said self-discharge main gaps is parallel. The present utility model is suitable for not only series compensation device, also the series resonant type fault current limiter and fast bypass capacitors, it reduces the trigger discharge voltage value, improves the performance of protection coordination, and the trigger discharge stability and reliability.

s

### RELATED APPLICATIONS

This application is a United States National Stage Application filed under 35 U.S.C 371 of PCT Patent Application Serial No. PCT/CN2012/081591, filed Sep. 19, 2012, which claims Chinese Patent Application Serial No. 2011/20429075.3, filed Nov. 3, 2011, the disclosure of all of which are hereby incorporated by reference in their entirety.

### FIELD OF THE UTILITY MODEL

This utility model relates to power equipment, in particular, relates to a compulsory triggered spark gap system with double gaps in series.

### BACKGROUND OF THE UTILITY MODEL

At present, there is no compulsory triggered spark gap system that is used for serial capacitor compensation device of the alternating current power system. The spark gap system is generally composed of two gaps in series. When need the spark gap to act the bypass serial compensation capacitors, the serial compensation control and protection system will send commands to the gap trigged control box through the optical fiber, and then the gap trigged control box sends the trigging signals to the gap system. The spark gap discharges to bypass capacitor finally. Most test researches suggest that, the sealing clearance used can improve trigging reliability in the system, however, there will happen serious polarity effect when discharges only at one side electrode of the sealing clearance, the ignition discharge voltage of one voltage polarity is very low, while another is very high and has big delay. The polarity effect can be eliminated only when the high and low voltage electrodes simultaneous ignition. And this makes the polarity voltages low both of them,

Only the ignition at the same time to eliminate the polarity effect in the high, low-voltage electrode sealing gap, so that the two polar reliable ignition discharge voltage is very low, it effectively improves the performance of protection coordination, that improves the discharge stability and reliability when triggering spark gap at the same voltage.

### SUMMARY OF THE UTILITY MODEL

In order to overcome the defects of the prior art, the utility model provides a compulsory triggered spark gap system with double gaps in series, and it reduces the trigger discharge voltage value, and improves the performance of protection coordination, and the trigger discharge stability and reliability.

In order to achieve the above objects, the utility model provides the following technical scheme:

It is a compulsory triggered spark gap system with double gaps in series, said spark gap system comprises two self-discharge main gaps in series G1, G2 and a gap trigger system, the two ends of the spark gap system are respectively connected with the high voltage end and low voltage end; said gap trigger system and said self-discharge main gaps is parallel.

Said self-discharge main gaps comprise a metal shell, the flashover gap and the continuous current gap.

Said continuous current gap is composed of the upper electrode and the lower electrode, said the upper and lower electrodes are both cylindrical shape, and the gap sides of the two electrodes are set a current oblique with same direction.

There are four equalizing capacitors between said self-discharge main gaps G1 and G2, two of said equalizing capacitors are connected with said self-discharge main gap G1 in parallel, another two equalizing capacitors are connected with said self-discharge main gap G2 in parallel.

Said gap trigger system comprises a trigger control box TC, two pulse transformers T1, T2, two sealing clearance TG1, TG2, two current-limiting resistors R1,R2 and two high insulation pulse transformers HT1,HT2.

The output of said trigger control box TC is connected with the primary windings of said pulse transformer T1 and high insulation pulse transformers HT1; said sealing clearance TG1, current-limiting resistors R1 are connected with the primary windings of said pulse transformer T2 and high insulation pulse transformers HT2 in series, and then connected with equalizing capacitor C1 in parallel; said sealing clearance TG2 is connected with said current-limiting resistors R2 in series, and then connected with equalizing capacitor C2 in parallel; the secondary windings of said pulse transformers T1 and T2 are respectively connected with the low voltage ends of the sealing clearance TG1 and TG2, the secondary windings of said high insulation pulse transformers HT1 and HT2 are respectively connected with the high voltage ends of the sealing clearance TG1 and TG2.

Said trigger control box TC receives external trigger commands, and sends trigger signals to said gap trigger system at the same time.

The high and low voltage polar of said sealing clearance TG1 and TG2 ignite at the same time.

Compared with the prior art, the utility model has the advantages that: it is suitable for not only series compensation device, also the series resonant type fault current limiter and fast bypass capacitors, it reduces the trigger discharge voltage value, improves the performance of protection coordination, and the trigger discharge stability and reliability.

### BRIEF DESCRIPTION OF THE DRAWINGS

FIG. 1 is the system composition and work principle diagram of a compulsory triggered spark gap system with double gaps in series.

### DETAILED DESCRIPTION OF EMBODIMENTS

The detail of the embodiments is described as below incorporated with the FIGURES by way of cross-reference for the present utility model.

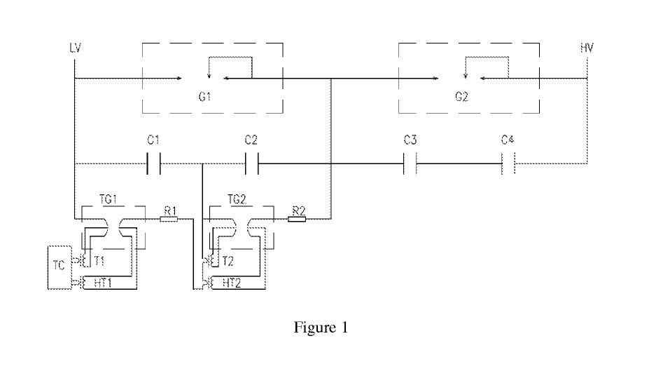

As shown in FIG. 1, a compulsory triggered spark gap system with double gaps in series, said spark gap system includes two self-discharge main gaps in series G1, G2 and a gap trigger system, the two ends of the spark gap system are respectively connected with the high voltage end and low voltage end; said gap trigger system and said self-discharge main gaps is parallel.

Said self-discharge main gaps include a metal shell, the flashover gap and the continuous current gap.

Said continuous current gap is composed of the upper electrode and the lower electrode, said the upper and lower electrodes are both cylindrical shape, and the gap sides of the two electrodes are set a current oblique with same direction.

There are four equalizing capacitors between said self-discharge main gaps G1 and G2, two of said equalizing capacitors are connected with said self-discharge main gap G1 in parallel, another two equalizing capacitors are connected with said self-discharge main gap G2 in parallel.

Said gap trigger system includes a trigger control box TC, two pulse transformers T1, T2, two sealing clearance TG1, TG2, two current-limiting resistors R1,R2 and two high insulation pulse transformers HT1,HT2.

The output of said trigger control box TC is connected with the primary windings of said pulse transformer T1 and high insulation pulse transformers HT1; said sealing clearance TG1, current-limiting resistors R1 are connected with the primary windings of said pulse transformer T2 and high insulation pulse transformers HT2 in series, and then connected with equalizing capacitor C1 in parallel; said sealing clearance TG2 is connected with said current-limiting resistors R2 in series, and then connected with equalizing capacitor C2 in parallel; the secondary windings of said pulse transformers T1 and T2 are respectively connected with the low voltage ends of the sealing clearance TG1 and TG2, the secondary windings of said high insulation pulse transformers HT1 and HT2 are respectively connected with the high voltage ends of the sealing clearance TG1 and TG2.

Said trigger control box TC receives external trigger commands, and sends trigger signals to said gap trigger system at the same time.

The high and low voltage polar of said sealing clearance TG1 and TG2 ignite at the same time.

The work principle of the compulsory triggered spark gap system with double gaps in series is as following: because of the equalizing capacitors C1, C2, C3 and C4, the two self-discharge main gap G1 and G2 both afford ½ of the series compensation capacitors rated voltage when the series compensation device work normally. When ground fault happens, the self-discharge main gap G1 and G2 afford voltage is about UPL/2 before action if the highest voltage of capacitors is up to UPL because of the voltage limiter. The internal of main gap is composed of flashover gap and continuous gap, where the flashover gap is the discharge beginning gap, and the gap distance will adjust self-discharge voltage that will not be less than 1.1 UPL/2, to ensure the gap will not self-discharge without trigger even if under the maximum possible over voltage afford.

When ground fault happens, if the capacitors over voltage UPL is limited by the voltage limiter (MOV), each of the two self-discharge main gaps in series will affords UPL/2 before the receiving the trigger command. After the spark gap triggers the trigger control box TC and receives the trigger signals from the series compensation control and protection device, the TC will send the ignition pulse to the primary windings of said pulse transformer T1 and high insulation pulse transformers HT1, and the two electrodes of the sealing clearance TG1 will spark discharge, the sealing clearance TG1 will be quickly breakdown. After that, the equalizing capacitor C1 will discharge though the primary windings of said pulse transformer T2 and high insulation pulse transformers HT2 and the current-limiting resistors R1, and the secondary windings of said pulse transformer T2 and high insulation pulse transformers HT2 will produce high voltage pulse, it will make the two electrodes of the sealing clearance TG2 discharge, and the sealing clearance TG2 also will be quickly breakdown, and the equalizing capacitor C1 will discharge though the current-limiting resistors R2. When the voltages of the equalizing capacitor C1 and C2 decrease quickly, the voltage of the self-discharge main gap G2 will increase quickly to self-discharge level and the G2 will breakdown and discharge, at the same time the voltage of the self-discharge main gap G1 will increase quickly to self-discharge level and the G2 will breakdown and discharge. So two main gaps connected in series both discharge, the series compensation capacitors and voltage limiter (the equipment protected) are all bypassed.

While the invention has been described and illustrated herein by reference to special examples. Numerous variations of such details can be implied and will be appreciated by those skilled in the art.

What is claimed is:

1. A compulsory triggered spark gap system with double gaps in series, is characterized that, said spark gap system includes two self-discharge main gaps in series G1, G2 and a gap trigger system, the two ends of the spark gap system are respectively connected with the high voltage end and low voltage end; said gap trigger system and said self-discharge main gaps is parallel.

2. A compulsory triggered spark gap system with double gaps in series according to claim 1, wherein said self-discharge main gaps include a metal shell, the flashover gap and the continuous current gap.

3. A compulsory triggered spark gap system with double gaps in series according to claim 2, wherein said continuous current gap is composed of the upper electrode and the lower electrode, said the upper and lower electrodes are both cylindrical shape, and the gap sides of the two electrodes are set a current oblique with same direction.

4. A compulsory triggered spark gap system with double gaps in series according to claim 2, wherein there are four equalizing capacitors between said self-discharge main gaps G1 and G2, two of said equalizing capacitors are connected with said self-discharge main gap G1 in parallel, another two equalizing capacitors are connected with said self-discharge main gap G2 in parallel.

5. A compulsory triggered spark gap system with double gaps in series according to claim 1, wherein said gap trigger system includes a trigger control box TC, two pulse transformers T1, T2, two sealing clearance TG1, TG2, two current-limiting resistors R1,R2 and two high insulation pulse transformers HT1,HT2.

6. A compulsory triggered spark gap system with double gaps in series according to claim 5, wherein the output of said trigger control box TC is connected with the primary windings of said pulse transformer T1 and high insulation pulse transformers HT1; said sealing clearance TG1, current-limiting resistors R1 are connected with the primary windings of said pulse transformer T2 and high insulation pulse transformers HT2 in series, and then connected with equalizing capacitor C1 in parallel; said sealing clearance TG2 is connected with said current-limiting resistors R2 in series, and then connected with equalizing capacitor C2 in parallel; the secondary windings of said pulse transformers T1 and T2 are respectively connected with the low voltage ends of the sealing clearance TG1 and TG2, the secondary windings of said high insulation pulse transformers HT1 and HT2 are respectively connected with the high voltage ends of the sealing clearance TG1 and TG2.

7. A compulsory triggered spark gap system with double gaps in series according to claim 6, wherein said trigger control box TC receives external trigger commands, and sends trigger signals to said gap trigger system at the same time.

8. A compulsory triggered spark gap system with double gaps in series according to claim 7, herein said the high and low voltage polar of said sealing clearance TG1 and TG2 ignite at the same time.
